(19) United States
(12) Patent Application Publication
(10) Pub. No.: US 2007/0164163 A1
(43) Pub. Date: Jul. 19, 2007

(54) Integral accumulator valve and ram module with seal heater

(75) Inventors: Thaddeus M. Jakubowski JR., St. Charles, MO (US); John K. Foster, St. Peters, MO (US); Paul A. Kersens, St. Louis, MO (US)

Correspondence Address: WILDMAN HARROLD ALLEN & DIXON LLP;AND THE BOEING COMPANY, 225 W. WACKER DR., CHICAGO, IL, 60606, US

(73) Assignee: THE BOEING COMPANY, Chicago, IL (US)

(21) Appl. No.: 11/335,324

(22) Filed: Jan. 19, 2006

(51) Int. Cl. B64D 1/12

(52) U.S. Cl. 244/137.4

(57) ABSTRACT

A system and method is provided for pre-heating seals in an unpressurized gas-powered stores ejection system. The system and method allow the seals of the stores ejection system to be made pliable when operating at a low ambient temperature, and thus reliably seal during operation in Arctic cold start environments.

### BACKGROUND OF THE INVENTION

1. Field of the Invention

This invention relates generally to store carriers for mounting a releasable store on an aircraft and, more particularly, to a stores ejection system from which a store is released with ejective force applied pressurized gas, such as air.

2. Background Description

Pneumatic stores carriage/ejector systems have been developed that utilize high-pressure (e.g., 6,000 psi) gas stored in a pressure vessel to eject stores, such as bombs, missiles, and the like. An example of such a system is disclosed in U.S. Pat. No. 5,583,312, the entirety of which is hereby incorporated by reference herein.

These pneumatic stores carriage/ejector systems may use an integral valve/accumulator module to store the pressure in an accumulator affixed to a valve. Examples of such systems are disclosed, for example, in U.S. Pat. Nos. 6,347,768 and 5,857,647, the entirety of which are hereby incorporated by reference herein. Such systems operate generally as follows: when electrically triggered, a large dump valve is opened; the opening of the dump valve simultaneously provides pressure to a hook opening system and the ejector rams which force the store away.

Although these systems provide a clean and effective means of ejecting stores, a deficiency exists in the technology which limits the operation use of the systems. The deficiency is that the current state-of-the-art seals do not reliably seal at extremely low temperatures, thereby limiting the deployment envelope of the systems.

The aforementioned stores carriage/ejection systems provide weapons release by storing and appropriately releasing energy in the form of very high pressure (e.g., 6,000 psi) gas. The systems use seals that are typically made from resilient materials, such as rubber, or alternatively synthetic elastomer materials.

In basic terms, sealing is achieved by the resilient material distorting or flowing under pressure into the gap area between mating parts, forming a seal. At extremely cold temperatures, seal materials tend to get hard and in this hardened state can not reliably distort or flow to seal gaps.

When pressurized at ambient temperatures the integral valve/accumulator module system can be transitioned to extreme cold temperatures (e.g., −65° F.) without seal degradation. However, when attempting to fill these systems from empty at very low temperatures (e.g., below −30° F.) the seals are too rigid and do not reliably and repeatably seal. This cold start condition may occur, for example, when attempting to fill an empty military weapon release system in an Arctic environment.

The present invention is directed to overcoming one or more of the problems or disadvantages associated with the prior art.

### SUMMARY OF THE INVENTION

This disclosure provides a means of pre-heating the seals of an unpressurized gas-powered stores ejection system to allow the seals to be more pliable at low temperature and thus reliably seal during Arctic cold start environments. According to one aspect of the invention, a stores ejection system is provided for mounting a jettisonable store on an aircraft which includes an on-board source of pressurized non-pyrotechnic gas, at least one release mechanism for releasably mounting the store, an actuation system for the release mechanism, and a heater for ensuring that seals associated with the stores ejection system remain pliable at extremely low temperatures. The heater advantageously may provide that the seals remain pliable even when the stores ejection system is unpressurized at low temperatures.

The features, functions, and advantages can be achieved independently in various embodiments of the present invention or may be combined in yet other embodiments.

### BRIEF DESCRIPTION OF THE DRAWINGS

FIG. 1 is a schematic view of the stores ejection system of the invention;

FIG. 2 is a side view of a suspension and release equipment (S & RE) module to be employed in the inventive stores ejection system, illustrating the various elements and their arrangement within the system; and

FIG. 3 is an enlarged partial cross-sectional view of the pneumatic actuation system employed in the S & RE module shown in FIG. 2.

### DETAILED DESCRIPTION

This disclosure adds a heater element into an integrated accumulator valve/release piston system. In an Arctic environment, the heater element may be used to preheat an accumulator valve module prior to high pressure gas being supplied. With the mass on the materials being pre-heated, the seals remain resilient and can properly flow into a sealing position at the time the high pressure gas is added.

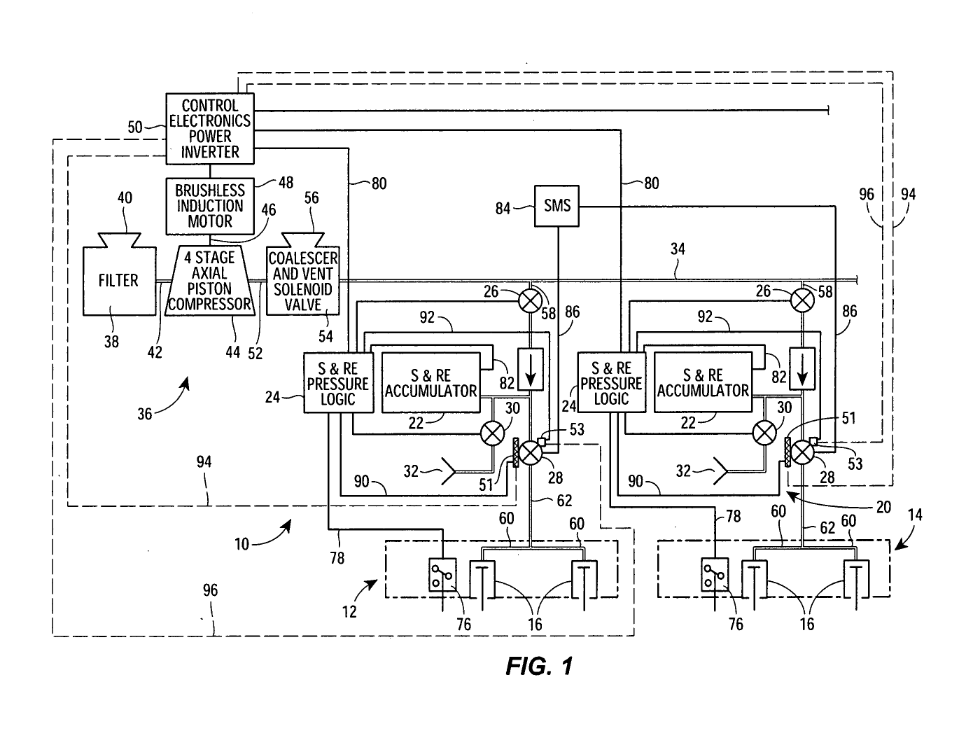

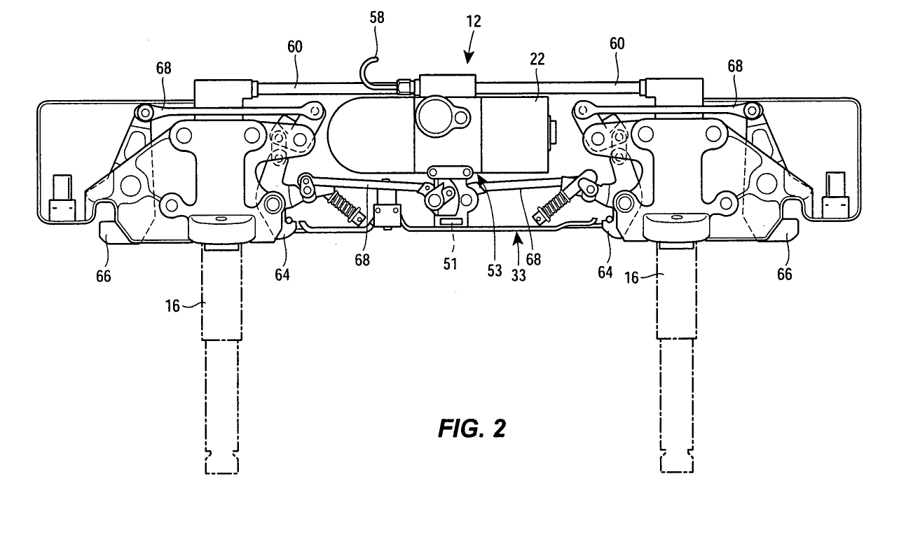

With reference initially to FIG. 1, a pneumatically driven stores ejection system 10 is illustrated schematically. In the illustrated preferred embodiment, two S & RE modules 12 and 14 are included in the system 10, though in actuality any number of such modules may be employed, depending upon the configuration of the aircraft and weapons system with which the system 10 is to be used. The S & RE modules 12, 14 are basically identical stand-alone mechanical units, each preferably comprising a mechanism for releasably retaining and jettisoning a store, including a pair of ejector pistons 16 for thrusting the store clear of the aircraft, and an actuation system for actuating the ejector pistons, including an accumulator 22, an accumulator pressure logic controller 24, an enable valve 26, an ejection dump valve 28, an over-pressure valve 30, and an over-pressure vent 32. In the preferred embodiment, all of these elements are commonly housed within the housing 33 of each module 12, 14 (FIG. 2), for compactness and modularity, but various arrangements could be employed within the scope of the invention, including arrangements wherein some or all of the elements other than the pistons 16 are housed within the aircraft remote from the housing 33.

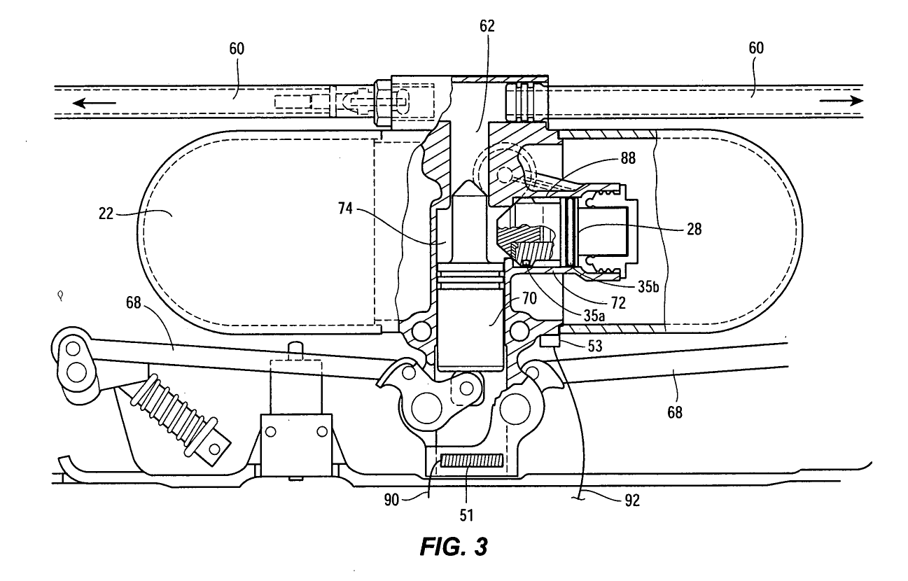

Each dump value 28 may include one or more seals, such as O-ring seals 35a and 35b (FIG. 3), that may be made from synthetic rubber.

With further reference to FIG. 1, a manifold conduit 34 provides pressurized fluid, preferably compressed air, from a remotely located pressurization unit 36 to each of the modules 12, 14. Preferably, the pressurization unit 36 incorporates ambient air filtration by means of a filter unit 38 having an ambient air inlet 40. The air then travels via a flow passage 42 through a compressor 44. While a four stage axial piston compressor is preferred, any known type suitable for the inventive application may be alternatively installed. The compressor is preferably driven through a shaft 46 by an electric motor 48 of known type, which in turn is controlled by a control unit 50.

A heater element 51 (that may be an electrical resistance type heater) and a thermocouple 53, that each may be operatively connected to the pressure logic controller 24 via control lines 90 and 92, respectively, may be embedded within each dump valve 28 for heating the O-ring seals 35a, and 35b, in a controlled manner, as may be required prior to pressurization. For example, each heater element 51 may be embedded within the material (e.g., steel) of the housing 33, and the heat produced by each heater element 51 may be conducted through the material of the housing 33 to the O-ring seals 35a and 35b.

Alternatively or additionally, each heater element 51 and/or each thermocouple 53 may be operatively connected to the control unit 50, as indicated by dashed control lines 94 and 96, respectively, in FIG. 1. As a further alternative, the heater may be controlled using a thermocouple in the control circuitry (e.g., a thermocouple in circuitry of the pressure logic controller 24 that essentially senses ambient temperature to determine the level of heating necessary). Upon exiting the compressor 44, the compressed air travels through a flow passage 52 into a coalescer and vent solenoid valve unit 54, which provides a dual function of drying the air and also operating as a solenoid valve. From the coalescer and vent solenoid valve unit 54, the dry air exits into the manifold conduit 34, while the excess moisture is vented through a moisture vent 56.

While the pressurization unit 36 shown and described is preferred, many alternate embodiments are possible. For example, the filter unit 40 is utilized to minimize wear to the system due to impurities in the ambient air, but is not required. Furthermore, the compressor 44 could alternatively be driven hydraulically or may be driven by or comprise a portion of the main aircraft engines. Also, while air is preferred, any known clean gas could be used, and the pressurization unit 36 could actually comprise part of an onboard oxygen or nitrogen generating system. Dry air is desirable in order to minimize system corrosion and because water freezes at high altitude ambient temperatures, resulting in further corrosive conditions within the system. Thus, the use of a drying unit, such as the coalescer and vent solenoid valve unit 54, is preferred. However, the system could be operated without such a unit, albeit with increased required maintenance. Finally, while a single gas generator 36 operated to supply gas to plural S & RE modules is preferred, independent generators for each S & RE module could be used as well, particularly since many available gas generating systems are relatively light and miniaturized, so that undue weight and space penalties are not imposed.

Now with reference to FIGS. 2 and 3, certain particular preferred structural details of the S & RE module 12 are illustrated. It should, of course, be noted that the structure of each of the S & RE modules forming a part of the system 10 are essentially identical, so that FIGS. 2 and 3 could just as well illustrate the S & RE module 14, or any other S & RE module forming a part of the system 10.

Structurally, the compressor feed line 58 (FIGS. 1 and 2) draws pressurized air from the manifold line 34 into the accumulator 22. Passages 60 provide fluid communication between the accumulator 22 and the pistons 16, in order to actuate the pistons at a desired time, drawing air from a dump valve exit flow line 62 downstream of the dump valve 28. Inside hooks 64 and outside hooks 66 of a type well known in the art are preferably employed to releasably secure the store to the S & RE module in well known fashion. The hooks 64, 66 may be actuated to an open position by means of a hinged hook opening linkage 68, as is also well known in the art, which in turn is driven by a hook opening piston 70 (FIG. 3). The piston 70 is reciprocatingly driven when the dump valve 28, which is pilot pressure-actuated, is driven from the illustrated closed position to an open position, thereby permitting pressurized air from the accumulator 22 to travel through port 72 into the valve area, from whence it further flows into piston chamber 74, thus acting to drive the piston 70 reciprocatingly downwardly to actuate the hook opening linkage 68. At the same time, pressurized air is also permitted by the open valve 28 to flow through the dump valve exit flow line 62 and into the passages 60, thereby actuating the ejector pistons 16 to thrust the store away from the aircraft simultaneously with its release from the hooks 64, 66.

In operation, each S & RE module 12, 14 is initially in an unpressurized state. Loading of a store onto an S & RE module 12, 14 triggers a “store present” signal on a store present switch 76 provided in each module 12, 14. This signal is transmitted by a control line 78 to the pressure logic controller 24, which further transmits it through a second control line 80 to the control unit 50. When the aircraft electrical system is powered up, the “store present” signal causes the pressure logic controller 24 to activate the heaters 51, if necessary due to low ambient temperature, and upon heating of the O-ring seals 35a, 35b, 35c, and 35d to an adequate temperature, based on readings from thermocouples 53, as processed by the pressure logic controller 24, to initiate the pressurization unit 36 by starting the compressor 44, to pressurize each module 12, 14. The pressure logic controller 24 maybe programmed to cycle the heaters 51 on and off, as necessary in order to ensure that the O-ring seals 35a, 35b, 35c, and 35d are maintained at a temperature at which the O-ring seals 35a, 35b, 35c, and 35d are pliable. Pressurized air thus flows through the manifold conduit 34 and into each of the S & RE modules 12, 14 through feed lines 58. When pressure in the accumulator 22 reaches a prescribed pressure, which in the preferred embodiment is approximately 6,000 psi, as detected by the pressure logic controller 24 via a third control line 82, the enable valve 26 (which is preferably a solenoid-operated check valve) closes, isolating the S & RE module 12, 14. When all S & RE modules reach the prescribed pressure, the remotely located pressurization system 36 is shut down. Each S & RE monitor and control system 24 continuously monitors accumulator pressure and periodically activates the pressurization system 36 or vents the accumulator through the over-pressure valve 30 and over-pressure vent 32 to maintain the prescribed pressure.

The aircraft stores management system (SMS) 84, which is preferably of a type well known in the art, controls stores release. On the release command by the SMS 84, through a fourth control line 86, the pilot pressure-actuated high flow rate ejection dump valve 28 is actuated to an open position, permitting pressurized air from the accumulator 22 to flow through port 72 (FIG. 3) into the valve area, then into the piston chamber 74, where it simultaneously drives the piston 70 downwardly to release the hooks 64, 66 while also flowing through passages 62 and 60 to pressurize and drive each of the ejector pistons 16 to their extended positions, thus fully releasing and thrusting the store clear of the aircraft. As the hooks 64, 66 open, the store present switch 76 detects a “store gone” condition, which is transmitted to the control units 24, 50. The controller 24 ensures that its corresponding check valve 26 remains closed, isolating the S & RE system from further pressurization. At the end of the ejector piston stroke, vent ports 88 (FIG. 3) are exposed, preferably discharging substantially all residual accumulator pressure and permitting the spring loaded ejector pistons to retract to their stowed position.

Other aspects and features of the present invention can be obtained from a study of the drawings, the disclosure, and the appended claims.

What is claimed is:

1. A stores ejection system for mounting a jettisonable store on an aircraft, said stores ejection system using a gas as a source of energy and a transfer mechanism and comprising:
an on-board source of pressurized non-pyrotechnic gas for providing said source of energy and said transfer mechanism;
at least one pneumatically-driven release and jettison mechanism for releasably mounting said store;
an actuation system for said release mechanism, including an accumulator for receiving and storing pressurized gas from said on-board source of pressurized gas at a specified operating pressure, a dump valve, at least one seal associated with said dump valve; and
a heater for maintaining said at least one seal at a temperature at which said at least one seal remains pliable.

2. A stores ejection system as recited in claim 1, wherein said heater is an electrical heater.

3. A stores ejection system as recited in claim 1, wherein said heater is embedded within said dump valve.

4. A stores ejection system as recited in claim 3, wherein said heater is embedded within material of a housing of said dump valve.

5. A stores ejection system as recited in claim 1, further including a controller wherein said heater is operatively connected to said controller.

6. A stores ejection system as recited in claim 5, further including at least one thermocouple operatively connected to said controller.

7. A method of mounting a jettisonable store on an aircraft, said aircraft having a stores ejection system comprising an ejector mechanism and a storage device, an on-board source of pressurized non-pyrotechnic gas for providing a source of energy and a transfer mechanism, at least one pneumatically-driven release and jettison mechanism for releasably mounting said store, an actuation system for said release mechanism, including an accumulator for receiving and storing pressurized gas from said on-board source of pressurized gas at a specified operating pressure, a dump valve, and at least one seal associated with said dump valve, the method comprising:
heating said at least one seal to a temperature at which said at least one seal remains pliable; and
pressurizing said pneumatically-driven release and jettison mechanism.

8. The method of claim 7, further including sensing a temperature associated with said at least one seal.

9. The method of claim 8, further including controlling said heating using a controller.

10. The method of claim 7, wherein said heating is performed electrically.
